(19) United States
(12) Patent Application Publication
(10) Pub. No.: US 2010/0127606 A1
(43) Pub. Date: May 27, 2010

(54) SLOW OPEN SLOW CLOSE APPLIANCE HINGE ASSEMBLY

(75) Inventors: James J. Collene, Nevada, OH (US); Brian White, Shelby, OH (US)

Correspondence Address: FAY SHARPE LLP, 1228 Euclid Avenue, 5th Floor, The Halle Building, Cleveland, OH, 44115, US

(73) Assignee: Mansfield Assemblies Co.

(21) Appl. No.: 12/625,693

(22) Filed: Nov. 25, 2009

Related U.S. Application Data
(60) Provisional application No. 61/117,738, filed on Nov. 25, 2008.

(51) Int. Cl. E05F 3/20; A47B 96/00

(52) U.S. Cl. 312/327; 16/50; 16/54; 16/68

(57) ABSTRACT

A slow open slow close hinge assembly for an appliance includes a first hinge assembly including a base; a tab projecting outwardly from the base in a first direction; a support projecting outwardly from the base in a second direction; a hinge arm pivotably connected to the tab via a first pivot point; a tail portion extending through an opening in the base; a slow open slow close dampener operably connected between the support at a second pivot point and the tail portion at a third pivot point; wherein a neutral position for the dampener occurs when the first, second and third pivot points are aligned substantially in a straight line.

An appliance includes a body; a door; first and second hinge positions for pivotably connecting the door to the body; wherein each of the first and second hinges includes a base; a tab projecting outwardly from the base in a first direction; a support projecting outwardly from the base in a second direction; a hinge arm pivotably connected to the tab via a first pivot point; a tail portion extending through an opening in the base; a slow open slow close dampener operably connected between the support at a second pivot point and the tail portion at a third pivot point; wherein a neutral position for the dampener occurs when the first, second and third pivot points are aligned substantially in the same plane.

A slow open slow close dampener for an appliance hinge includes a body and a rod selectively extensible from and retractable into the body, wherein when the hinge moves from a first operative position, the rod retracts into the body, then the hinge moves to a neutral position and then the hinge moves to a second operative position and the rod extends out of the body.

### CLAIM OF PRIORITY

This application claims priority from and benefit of the filing date of U.S. Provisional Patent Application Ser. No. 61/117,738 filed on Nov. 25, 2008, which is hereby incorporated by reference.

### BACKGROUND OF THE DISCLOSURE

This disclosure relates to an appliance hinge assembly. More particularly, it relates to a slow open slow close appliance hinge assembly.

Appliances such as refrigerators, ovens and microwave ovens have hinged doors for accessing an interior compartment. For example, an oven has a body defining a cooking chamber having an opening selectively opened or closed by a door pivotably secured to the body and which pivots between a closed position and an open position. The door is pivotably connected to the body using hinge assemblies.

The hinge system of the present disclosure is described herein with reference to its use as an oven or stove door hinge system (the terms “oven” and “stove” may be used interchangeably herein). Those of ordinary skill in the art will appreciate, however, that a hinge system formed in accordance with the present disclosure can be used as a door hinge system for a wide variety of other appliances such as clothes washers and dryers, dishwashers and the like.

Appliance manufacturers continue to seek improved performance characteristics with respect to the connection of doors to the appliance body and movement of the door relative to the body. With respect to oven doors, manufacturers and consumers have expressed a desire for doors that exhibit dampened-open and/or dampened-close characteristics. In a typical configuration, the oven door must be pulled open manually until it defines an angle of about 30° with the oven body, at which time the oven door will fall under its own weight in a slow, gentle and controlled manner until it is fully open and defines an angle of 90° with the oven body. With dampened-close, the oven door is moved manually from the fully open (about 90°) position to a partially closed position (e.g., where it defines an angle of about 30° with the oven body) after which it closes the remainder of the distance in a slow, gentle and controlled manner under force of a spring or other biasing means that is part of the hinge assembly.

Prior attempts to provide an oven door exhibiting these dampened-open/dampened-close characteristics have been deemed sub-optimal for a wide variety of reasons. In prior arrangements, with respect to door opening, attempts have been made to reduce door-opening resistance (such as reducing counter-weight or reducing door-closing biasing force). This allows the door to open under its own weight, but has the undesired effect of increasing the speed at which the door opens which can lead to noise, vibration, damage to the oven and disruption of delicate contents of the oven such as soufflés or cakes.

In other prior arrangements, dampeners and/or gas-springs have been employed in tandem with conventional hinge assemblies in an effort to achieve the desired dampened-open and dampened-close effects. These dampeners and/or gas-springs have not been incorporated into the hinge assemblies. This leads to increased complexity which increases costs of manufacture and repair. Furthermore, to provide both dampened-open and dampened-close characteristics, the complexity increases even further.

Another problem with these hinge assemblies is that they do not provide for an effective dampening effect during opening and closing of the appliance door. Accordingly, it is desired to provide a slow open slow close appliance hinge assembly which overcomes the above-mentioned deficiencies and others while providing better and more advantageous overall results.

### BRIEF SUMMARY OF THE DISCLOSURE

This disclosure relates to a hinge for an appliance door. More particularly, it relates to a slow open slow close appliance hinge assembly.

In accordance with one aspect of the disclosure, a slow open slow close hinge assembly for an appliance has a first hinge assembly including a base; a tab projecting outwardly from the base in a first direction; a support projecting outwardly from the base in a second direction; a hinge arm pivotably connected to the tab via a first pivot point; a tail portion extending through an opening in the base; a slow open slow close dampener operably connected between the support at a second pivot point and the tail portion at a third pivot point; wherein a neutral position for the dampener occurs when the first, second and third pivot points are aligned substantially in a straight line.

In accordance with another aspect of the disclosure, an appliance includes a body; a door; first and second hinge positions for pivotably connecting the door to the body; wherein each of the first and second hinges includes a base; a tab projecting outwardly from the base in a first direction; a support projecting outwardly from the base in a second direction; a hinge arm pivotably connected to the tab via a first pivot point; a tail portion extending through an opening in the base; a slow open slow close dampener operably connected between the support at a second pivot point and the tail portion at a third pivot point; wherein a neutral position for the dampener occurs when the first, second and third pivot points are aligned substantially in the same plane.

In accordance with another aspect of the disclosure, a slow open slow close dampener for an appliance hinge includes a body and a rod selectively extensible from and retractable into the body, wherein when the hinge moves from a first operative position, the rod retracts into the body, the hinge moves to a neutral position and then the hinge moves to a second operative position and the rod extends out of the body.

Another aspect of the disclosure is a hinge assembly which has a slow open slow close damper system.

Another aspect of the disclosure is the damper has asymmetric dampening characteristics wherein more resistance occurs during extension of a dampening rod and less resistance occurs during insertion of a dampening rod.

Yet another aspect of the disclosure is the damper includes a piston and rod which are extended and retracted and dampened by gas or other fluid.

Still another aspect of the disclosure is a damper which provides damping when the door is opened and when the door is closed.

Still other aspects of the disclosure will become apparent after a reading and understanding of the following detailed description.

### BRIEF DESCRIPTION OF THE DRAWINGS

The disclosure comprises various components and arrangements of components, preferred embodiments of which are illustrated in the accompanying drawings that form a part hereof and wherein;

FIG. 1A is an isometric view of an oven with a door pivotably connected by a hinge assembly;

FIG. 1B is a second isometric view of an oven with a door pivotably connected by a hinge assembly;

FIG. 2A is a perspective view of a hinge assembly in a first operative position;

FIG. 2B is a perspective view of a hinge assembly in a second operative position;

FIG. 3A is a perspective view of a slow open slow close hinge assembly in a first operative position in accordance with a preferred embodiment of the present disclosure;

FIG. 3B is a perspective view of a slow open slow close hinge assembly in a second operative position in accordance with a preferred embodiment of the present disclosure;

FIG. 4A is a side elevational cross sectional view of a damper in an extension stroke;

FIG. 4B is an enlarged side elevational view in cross section of a piston assembly of the dampener of FIG. 4A;

FIG. 4C is a side elevational cross sectional view of a damper in a compression stroke;

FIG. 4D is an enlarged side elevational view in cross section of a piston assembly of the dampener of FIG. 4C;

FIG. 5A is a side elevational view of a slow open slow close hinge assembly in a first operative position in accordance with a preferred embodiment of the present disclosure;

FIG. 5B is a side elevational view of a slow open slow close hinge assembly in an intermediate operative position in accordance with a preferred embodiment of the present disclosure; and

FIG. 5C is a side elevational view of a slow open slow close hinge assembly in a second operative position in accordance with a preferred embodiment of the present disclosure.

### DETAILED DESCRIPTION OF THE PREFERRED EMBODIMENT

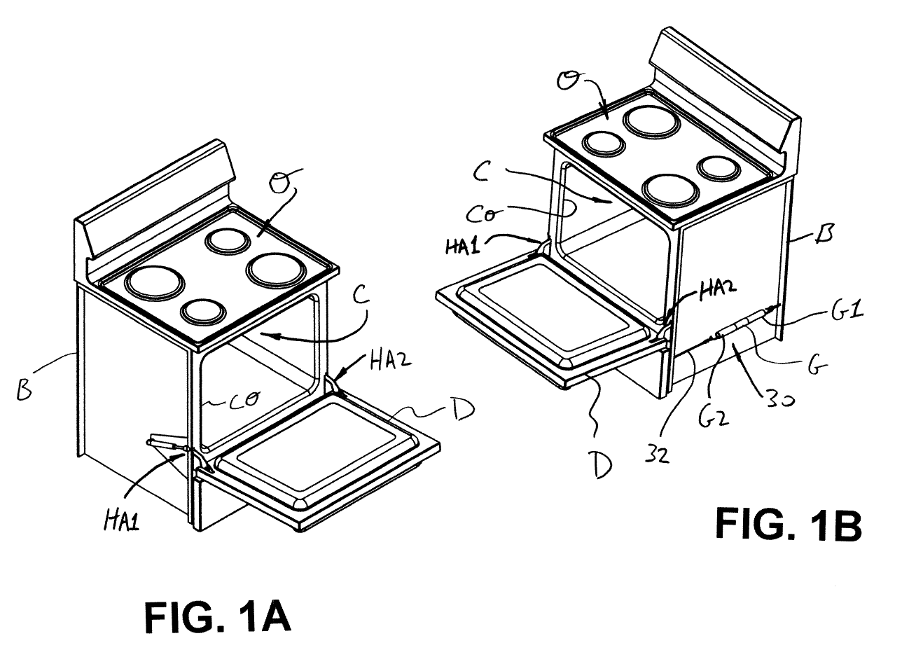

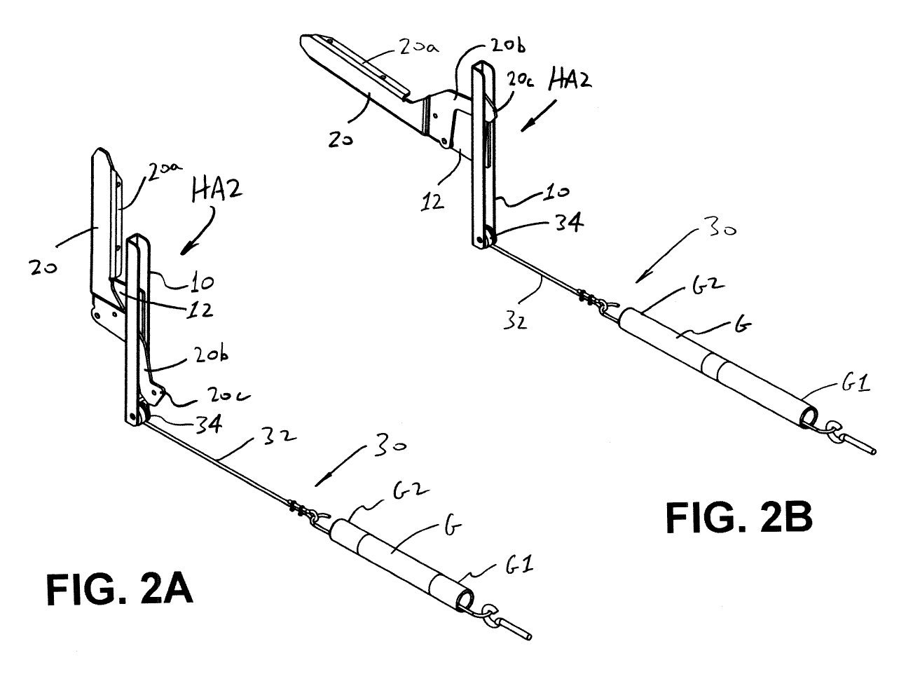

Referring now to the drawings, which are for purposes of illustrating a preferred embodiment only and are not intended to be limiting in any way, a stove or oven O is shown in FIGS. 1A and 1B and includes a dampened hinge system. The oven O, apart from the dampened hinge system, is conventional and comprises a body B and a door D. The door D is movable to a closed position and an opened position as shown in FIGS. 2A and 2B.

Specifically, FIGS. 1A and 1B are first and second isometric views of an oven O including a body B that defines a cooking chamber C having an opening CO that is selectively covered or closed by a door D pivotally secured to the body B and adapted to pivot between: (i) a closed position (not shown) where the door D is generally vertically oriented and covers the cooking chamber opening CO; and, (ii) an opened position (shown) wherein the door D is pivoted about a horizontal pivot axis away from the cooking chamber opening CO, usually to approximately a horizontal position, to allow access to the cooking chamber C. The door D is pivotally connected to the body B using first (left) and second (right) hinge assemblies HA1 and HA2, respectively. According to the present disclosure, at least one or both of the hinge assemblies HA1 and HA2 is structured as a slow open slow close hinge assembly in accordance with the present disclosure. As described herein, the hinge assembly HA1 is a slow open slow close hinge assembly formed in accordance with the present disclosure, while the hinge assembly HA2 is a conventional hinge assembly.

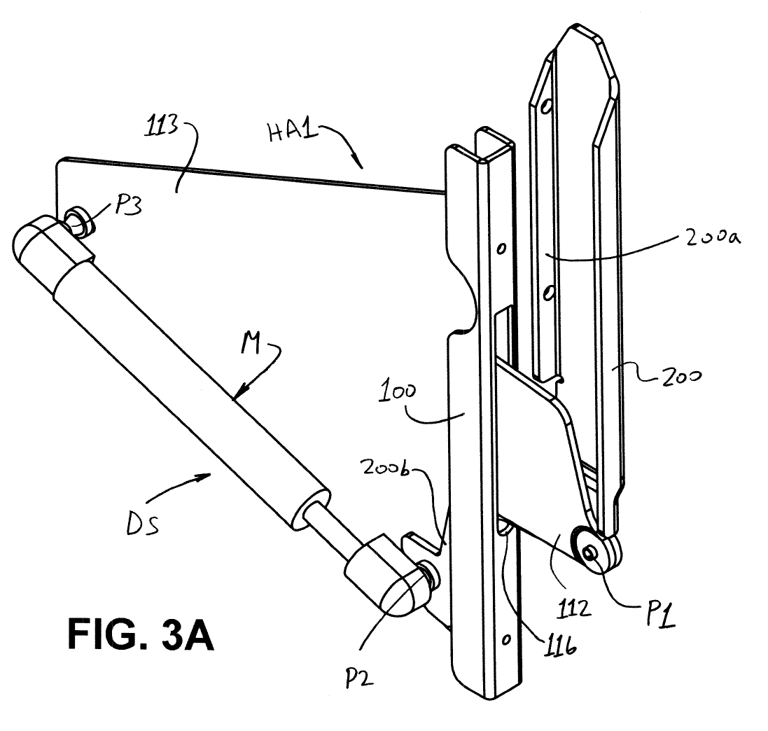

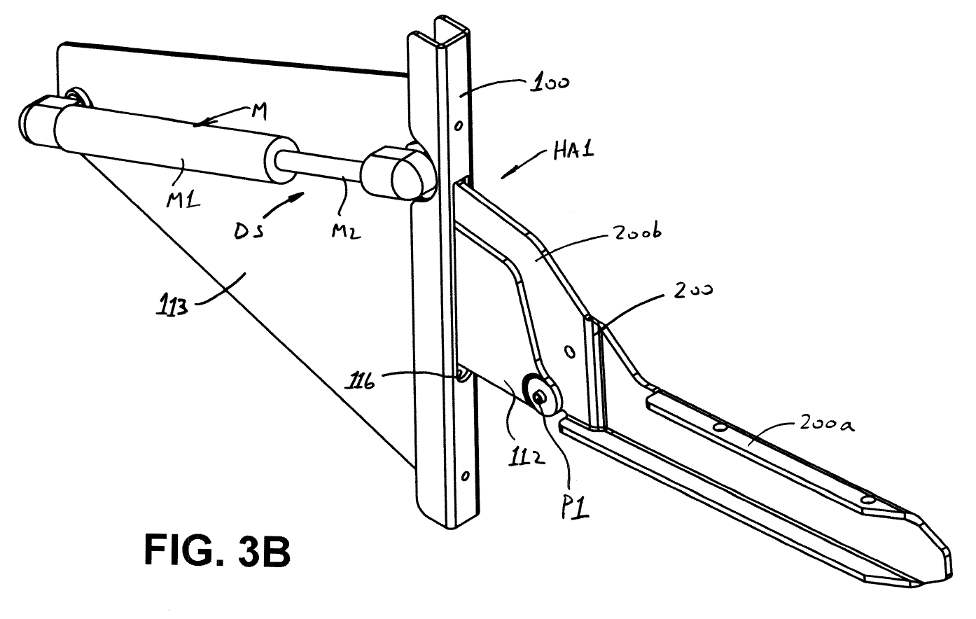

In the illustrated example, the conventional hinge assembly HA2 is constructed, e.g., as shown in FIGS. 2A and 2B. It is not intended that the present disclosure be limited to the illustrated conventional hinge assembly HA2 or any other particular type of conventional hinge assembly HA2 (also, as noted above, both hinge assemblies HA1 and HA2 can be slow open slow closed hinge assemblies according to the present disclosure as described below with reference to FIGS. 3A and 3B). FIG. 2A shows the hinge assembly HA2 in a first operative position corresponding to the closed position for the oven door D while FIG. 2B shows the hinge assembly HA2 in a second operative position corresponding to the opened position for the oven door D.

The hinge assembly HA2 comprises a base 10 adapted to be secured to the oven body B using fasteners such as rivets or screws or by welding or other suitable conventional means. The base 10 comprises a tab or ear 12 that projects outwardly therefrom. A hinge arm 20 is pivotally secured to the ear 12 using a rivet or other fastener and is adapted for pivoting movement relative to the base 10 so that the hinge arm pivots between the first and second operative positions as shown in FIGS. 2A and 2B. The hinge arm 20 includes a door mounting portion 20a adapted to be secured to the oven door D by fasteners such as screws or rivets or by welding or other suitable means. The hinge arm 20 further includes a tail portion 20b that projects from the door mounting portion 20a. As shown the tail portion 20b extends through an opening or slot defined in the base 10. The tail 20b has a distal end 20c connected to a spring G or another suitable counter-balance mechanism. The spring G, which can be a tension spring, a compression spring, a gas-spring, or other type, can be self-contained with respect to the hinge assembly HA2, e.g., by having one portion connected to the base 10 and another portion connected to the tail 20b. In the illustrated embodiment, the spring G is part of a counter-balance system 30 that is integrated into the oven O.

In particular, the illustrated counter-balance system 30 includes a coiled tension spring G having a first end G1 connected to the oven body B (see also FIG. 1B) and a second end G2 connected to a cable 32 that is, in turn, connected to the distal end 20c of the tail 20b. The cable 32 is engaged with a pulley 34 that is connected to the base 10 of the hinge (or is connected to the oven body B). The pulley 34 routes and guides the cable 32 such that movement of the hinge arm 20 from the first operative position (FIG. 2A) to the second operative position (FIG. 2B) resiliently lengthens or extends the spring G, while movement of the hinge arm 20 from the second operative position (FIG. 2A) to the first operative position (FIG. 2B) allows the spring to contract or compress. As such, the spring G exerts a biasing force on the tail 20 of the hinge arm 20 that biases the hinge arm 20 toward or into its first operative position.

FIGS. 3A and 3B are isometric views of the hinge assembly HA1 that is a slow open slow close hinge assembly formed in accordance with the present disclosure. FIG. 3A shows the hinge assembly HA1 in a first operative position corresponding to the closed position for the oven door D while FIG. 3B shows the hinge assembly HA1 in a second operative position corresponding to the opened position for the oven door D. The hinge assembly HA1 comprises a base 100 adapted to be secured to the oven body B using fasteners such as rivets or screws or by welding or other suitable conventional means. The base 100 comprises a tab or ear 112 that projects outwardly therefrom in a first or forward direction and a damper support 113 that projects outwardly therefrom in a second or rearward direction.

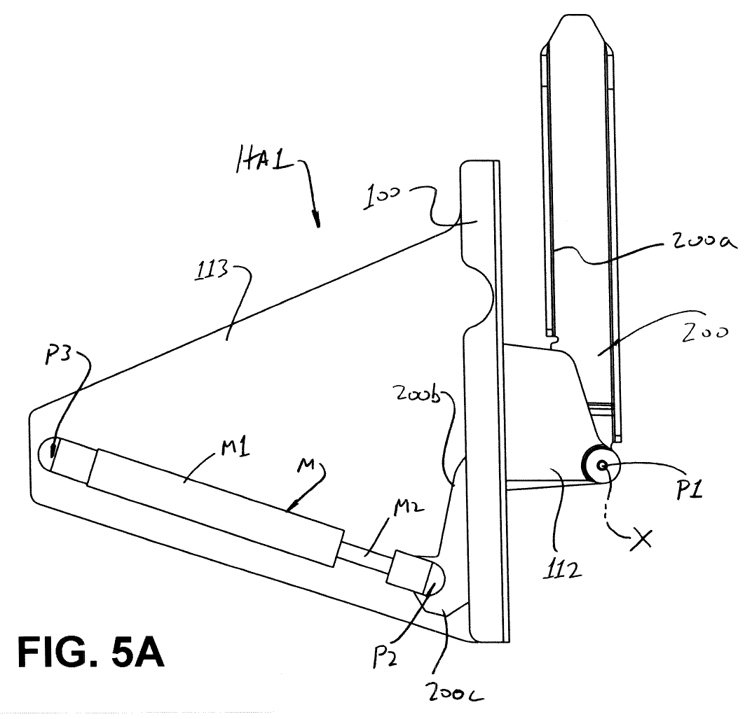

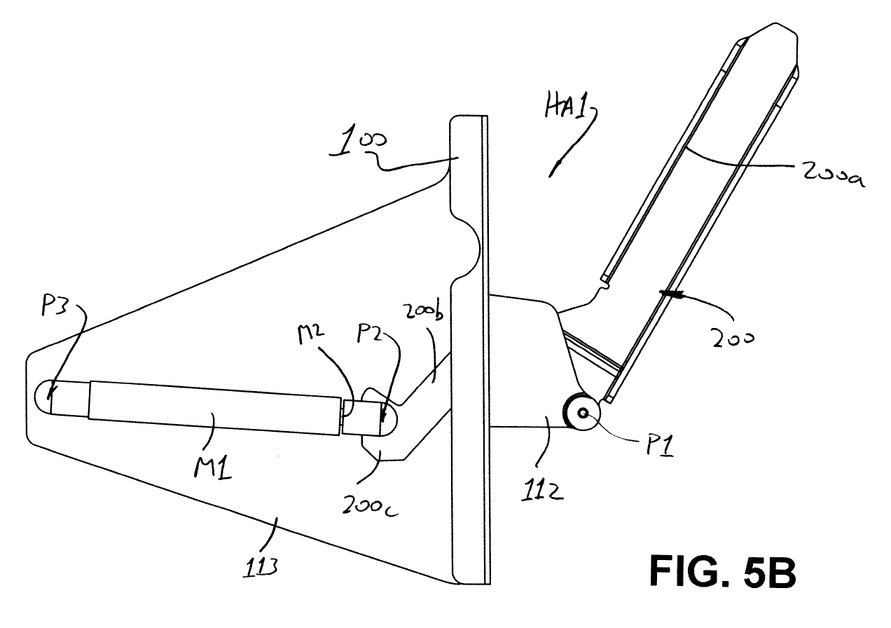

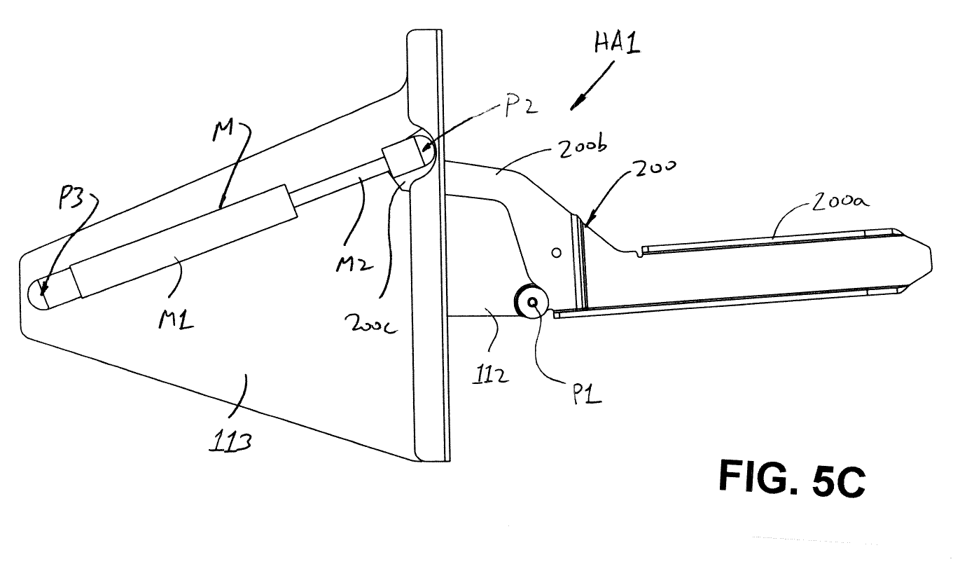

A hinge arm 200 is pivotally secured to the ear 112 at a pivot point P1 using a rivet or other suitable fastener and is adapted for pivoting movement relative to the base 100 about a horizontal pivot axis X (FIG. 5A) so that the hinge arm 200 can pivot between the first and second operative positions as shown in FIGS. 3A and 3B. The hinge arm 200 includes a door mounting portion 200a adapted to be secured to the oven door D by fasteners such as screws or rivets or by welding or other suitable means. The hinge arm 200 further includes a tail or tail portion 200b that projects from the door mounting portion 200a. As shown the tail portion 200b extends through an opening or elongated slot 116 defined in the base 100.

The hinge assembly HA1 further comprises a slow open slow close damper system DS comprising a damper M operably connected between the damper support 113 and the hinge arm tail 200b of the hinge arm 200. The damper M is pivotally connected to both the distal end 200c of the tail 200b and the damper support 113 at respective pivot points P2 and P3. More particularly, the damper M comprises a body M1 and a rod M2 that is selectively extensible from and is retractable or insertable into the body M1, one of which (the body M1 in the illustrated embodiment) is connected to the damper support 113 and the other of which (the rod M2 in the illustrated embodiment) is connected to the distal end 200c of hinge arm tail 200b.

The damper M is configured to have asymmetric dampening characteristics such that the resistance or dampening during extension of the rod M2 out of or from the body M1 is more than the resistance or dampening during retraction or insertion of the rod M2 back into the body M1. Preferably, the damper provides little or no resistance or dampening during retraction of the rod M2 back into the body M1. It is also preferred that the rod M2 not be biased toward either its extended or retracted position by a spring or fluid pressure, i.e., the rod M2 will be stationary in any extended or retracted position relative to the body M1 unless acted on by other forces. For example, the damper M can be defined as a fluid spring such as a gas spring comprising a gas that is acted upon by a piston located in a cylinder bore defined in the body M1, wherein the piston is connected to the rod M2 and is configured such that the gas provides or creates resistance to extension of the piston and rod M2 but provides or creates little or no resistance to retraction or insertion of the piston and rod M2. Alternatively or additionally, the fluid in the damper M can comprise a hydraulic oil or other liquid.

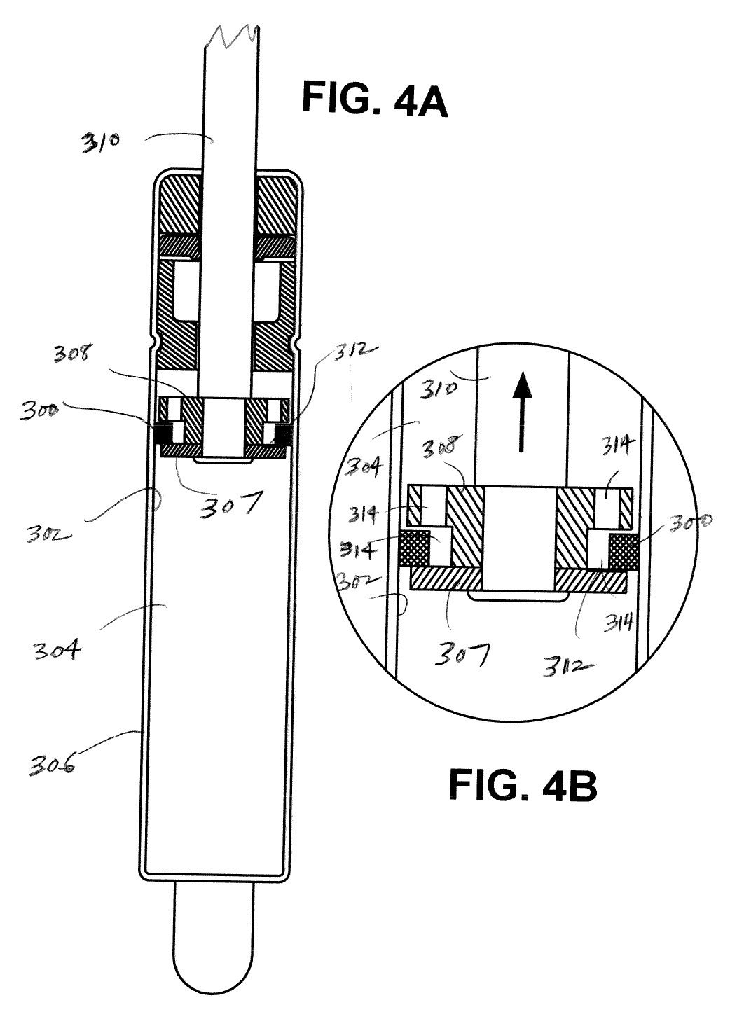

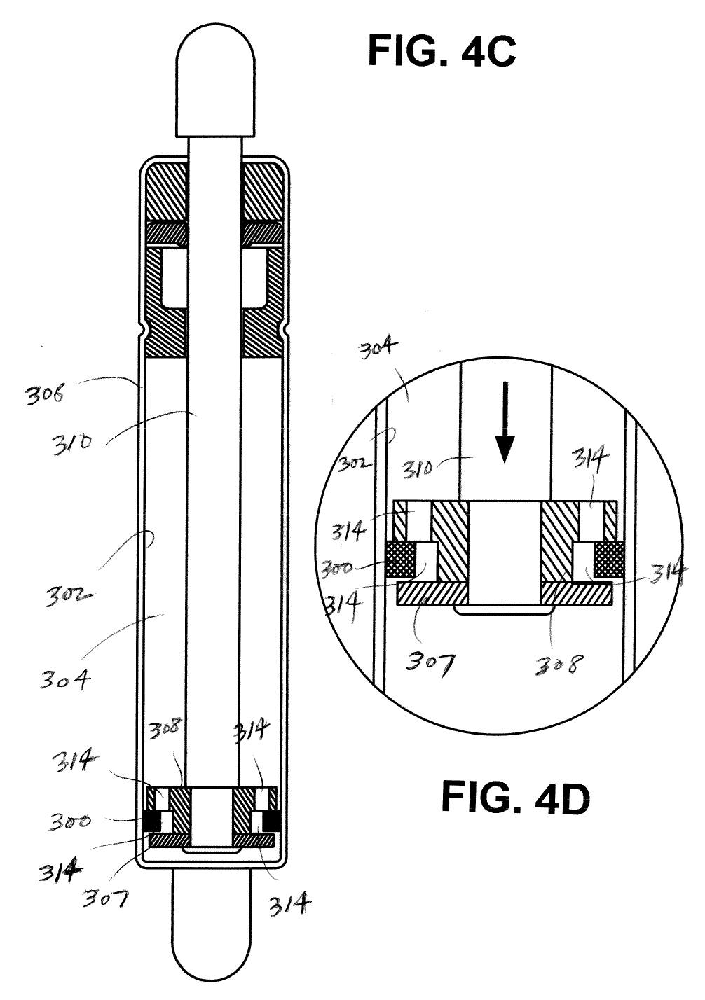

Specifically, during operation of the damper, referring now to FIGS. 4A and 4B, on an extension stroke, a piston 308 and rod 310 travel in the direction of the arrow in FIG. 4B, and friction between a washer 300 (such as a Teflon washer) and an inside wall 302 of a bore 304 of a damper cylindrical tube 306 keeps the washer pressed against a piston washer 307 of the piston 308 located in the bore 304. The piston 308 is connected to rod 310. By pressing the washer 300 against a surface of the piston washer 307, the fluid or gas is forced to travel through small indented holes or channels 312 formed in the piston wall. The fluid travels in the opposite direction of the arrow of FIG. 4B. In other words, the piston is configured such that gas or fluid provides resistance or dampening to the extension of the piston and rod out of the tube 306.

Referring now to FIGS. 4C and 4D, on the compression or retraction stroke, wherein the piston and rod travel in the direction of the arrow in FIG. 4D, friction between washer 300 and inside walls 302 of bore 304 of tube 306 keeps the washer 300 pressed against a surface of the piston 308. This allows the fluid or gas to freely pass or travel past the piston washer 307 and through four holes or channels 314 formed in the piston wall. The fluid travels in the opposite direction of the arrow of FIG. 4D. This results in little or no resistance or dampening of insertion or retraction of the piston and rod into tube 306.

Referring now to FIGS. 5A, 5B and 5C, the hinge assembly HA1 is shown in the first and second operative positions (FIGS. 5A and 5C) and also an intermediate position (FIG. 5B). It can be seen that movement of the hinge arm 200 from the first operative (i.e. door closed) position to the intermediate position illustrated in FIG. 5B requires counterclockwise pivoting movement of the damper M about pivot point P3 in a vertical plane and also retraction or insertion of the rod M2. The point at which projecting length of the rod M2 is minimized (maximum retraction or insertion of the rod M2 into body M1) can be referred to as a neutral position for the damping system and for the hinge arm 200 and damper M, which will occur when the pivot points P1,P2,P3 are arranged in a substantially straight line or are positioned in substantially along the same plane. Movement of the hinge arm 200 from the neutral position to its second (i.e. door opened) operative position as illustrated in FIG. 5C requires further counterclockwise pivoting movement of the damper M in the vertical plane about pivot point P3 and also extension of the rod M2. Likewise, reverse movement of the hinge arm 200 from the second operative position (FIG. 5C) to the first operative position (FIG. 5A) through the neutral position requires initial retraction or insertion of the rod M2 until the neutral position is reached followed by extension of the rod M2 from the neutral position to the first operative position. As such, the hinge arm 200 and/or damper system DS can be said to go “over-center” upon movement of the hinge arm 200 through the neutral position in either direction. Both opening and closing of the oven door D include a first step of retraction or insertion of the rod M2 followed by extension of the rod M2. Because of the above-described asymmetric dampening characteristics of the damper M, movement of the hinge arm 200 away from the neutral position is dampened by the damper M to a greater extent than movement of the hinge arm 200 toward the neutral position which means that, for both opening and closing of the oven door D, movement of the door D is dampened primarily (or at least to a greater extent) only after the hinge arm 200 goes over-center past the neutral position.

In one embodiment, the hinge assemblies HA1 and HA2 are configured such that the oven door D will counter-balance and remain stationary when the hinge arm 200 of the hinge assembly HA1 is in its neutral position as required for the door to balance partially open in a broil position. The pivot point P3 for connecting the damper M to the damper support 113 can be moved to control the position of the neutral position as measured by the angular position of the hinge arm 200 relative to a horizontal or vertical plane at the neutral position. In another embodiment, the hinge assemblies HA1 and HA2 are configured so that the oven door D will not counter-balance in a partially opened position, in which case the oven door D will always move to either its opened position or its closed position depending on the angular position of the hinge arm 200.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

Having thus described the preferred embodiment, what is claimed is:

1. A slow open slow close hinge assembly for an appliance, comprising:
a first hinge assembly comprising:
a base;
a tab projecting outwardly from said base in a first direction;
a support projecting outwardly from said base in a second direction;
a hinge arm pivotably connected to said tab via a first pivot point;
a tail portion extending through an opening in said base;
a slow open slow close dampener operably connected between said support at a second pivot point and said tail portion at a third pivot point;
wherein a neutral position for the dampener occurs when said first, second and third pivot points are aligned substantially in a straight line.

2. The slow open slow close hinge assembly of claim 1, wherein said dampener comprises a body and a rod selectively extensible from and retractable into said body, wherein one of said body and rod is attached to said support at the other of said body and rod is attached to said tail portion.

3. The slow open slow close hinge assembly of claim 1, wherein said dampener comprises a fluid spring.

4. The slow open slow close hinge assembly of claim 1, wherein said dampener comprises a gas spring.

5. The slow open slow close hinge assembly of claim 1, wherein said dampener comprises a hydraulic oil.

6. The slow open slow close hinge assembly of claim 2, wherein dampening during extension of said rod out of said body is greater than dampening during insertion of said rod into said body.

7. The slow open slow close hinge assembly of claim 1, wherein said base is secured to an associated appliance via fasteners.

8. The slow open slow close hinge assembly of claim 1, wherein said hinge arm comprises a door mounting position for securing said hinge arm to an associated door of an associated appliance via fasteners.

9. The slow open slow close hinge assembly of claim 8, wherein said tail position projects from said door mounting position.

10. The slow open slow close hinge assembly of claim 2, wherein said dampener comprises a piston connected to said rod, wherein gas provides more resistance to extension of said piston and said rod and less resistance to retraction of said piston and said rod.

11. The slow open slow close hinge assembly of claim 2, wherein said hinge arm pivots about said third pivot point from a first operative position to an intermediate position and said rod retracts into said body.

12. The slow open slow close hinge assembly of claim 11, wherein said hinge arm pivots about said third pivot point from said intermediate position to a second operative position and said rod extends from said body.

13. The slow open slow close hinge of claim 12, wherein said hinge arm pivots about said third pivot point from said second operative position to said intermediate position wherein said rod is inserted into said body, and said hinge arm pivots about said third pivot point from said intermediate position to said first operative position wherein said rod is extended from said body.

14. An appliance comprising:
a body;
a door;
first and second hinge positions for pivotably connecting said door to said body;
wherein each of said first and second hinges comprises:
a base;
a tab projecting outwardly from said base in a first direction;
a support projecting outwardly from said base in a second direction;
a hinge arm pivotably connected to said tab via a first pivot point;
a tail portion extending through an opening in said base;
a slow open slow close dampener operably connected between said support at a second pivot point and said tail portion at a third pivot point;
wherein a neutral position for the dampener occurs when said first, second and third pivot points are aligned substantially in the same plane.

15. The appliance of claim 14, wherein said dampener comprises a body and a rod selectively extensible from and retractable into said body, wherein one of said body and rod is attached to said support at the other of said body and rod is attached to said tail portion.

16. The appliance of claim 14, wherein said dampener comprises a fluid spring.

17. The appliance of claim 14, wherein said dampener comprises a gas spring.

18. The appliance of claim 15, wherein dampening during extension of said rod out of said body is greater than dampening during insertion of said rod into said body.

19. The appliance of claim 14, wherein said base is secured to an associated appliance via fasteners.

20. The appliance of claim 14, wherein said hinge arm comprises a door mounting position for securing said hinge arm to said door of said appliance via fasteners.

21. The appliance of claim 20, wherein said tail position projects from said door mounting position.

22. The appliance of claim 15, wherein said dampener comprises a piston connected to said rod, wherein gas provides more resistance to extension of said piston and said rod and provides less resistance to retraction of said piston and said rod.

23. The appliance of claim 15, wherein said hinge arm pivots about said third pivot point from a first operative position corresponding to a closed position of said door to an intermediate position and said rod retracts into said body.

24. The slow open slow close hinge assembly of claim 23, wherein said hinge arm pivots about said third pivot point from said intermediate neutral position to a second operative position corresponding to an open position of said door and said rod extends from said body.

25. The appliance of claim 24, wherein said hinge arm pivots about said third pivot point from said second operative position to said intermediate neutral position wherein said rod is inserted into said body, and said hinge arm pivots about said third pivot point from said intermediate neutral position to said first operative position wherein said rod is extended from said body.

26. A slow open slow close dampener for an appliance hinge comprising:
a body and a rod selectively extensible from and retractable into said body, wherein when said hinge moves from a first operative position, said rod retracts into said body, said hinge moves to a neutral position and then said hinge moves to a second operative position and said rod extends out of said body.
